(19) United States
(12) Patent Application Publication
(10) Pub. No.: US 2002/0147960 A1
(43) Pub. Date: Oct. 10, 2002

(54) Method and apparatus for determining scheduling for wafer processing in cluster tools with integrated metrology and defect control

(75) Inventors: Dusan B. Jevtic, Santa Clara, CA (US); Raja S. Sunkara, Santa Clara, CA (US)

Correspondence Address: Patent Counsel, APPLIED MATERIALS, INC., P.O. Box 450-A, Santa Clara, CA, 95052, US

(73) Assignee: Applied Materials, Inc.

(21) Appl. No.: 09/771,255

(22) Filed: Jan. 26, 2001

(51) Int. Cl. G06F 17/50

(52) U.S. Cl. 716/19

(57) ABSTRACT

Apparatus and concomitant method for performing priority based scheduling of wafer processing within a multiple chamber semiconductor wafer processing system (cluster tool) having at least one metrology chamber. The sequencer assigns priority values to the chambers and stations in a wafer processing system (i.e., a cluster tool plus a factory interface), then moves wafers from chamber to chamber in accordance with the assigned priorities. The sequencer also selects particular wafers for placement into at least one metrology chamber or station.

### BACKGROUND OF THE DISCLOSURE

1. Field of the Invention

The invention relates to multiple chamber wafer processing systems that have integrated metrology and defect control chambers and, more particularly, the invention relates to a method and apparatus for determining wafer scheduling in a multiple chamber wafer processing system that has at least one integrated metrology and defect control chamber.

2. Description of the Background Art

Semiconductor wafers are processed to produce integrated circuits using a plurality of sequential process steps. These steps are performed using a plurality of process chambers. An assemblage of process chambers served by a wafer transport robot is known as a multiple chamber semiconductor wafer processing tool or cluster tool. Movement of wafers through the cluster tool is controlled by a schedule.

A Factory Interface (FI), attached to the “front end” of a cluster tool, usually contains additional wafer positions (stations) for wafer orientation, metrology, and defect control, and introduces a number of challenges in wafer handling and movement. The wafer scheduling algorithms now must take into account sampling policies regarding metrology and defect control stations since these stations are integrated into the wafer processing system. The sampling policies typically require every nth wafer to be tested in a metrology or defect control station. As such, periodically cassettes of wafers are removed from the normal wafer flow for testing and the scheduling algorithm must handle such interruptions.

More precisely, if FPᵢ represent a load position i in the factory interface (there are usually two such positions) and Cᵢ represent a chamber i in the cluster tool, then

FPᵢ→C₁→C₂→. . .→C_{N}FPᵢ,

represents the wafer route through the system (FI plus cluster tool). If B(Cᵢ)ε{0,1} is a boolean variable representing whether a chamber in the tool or factory interface is visited, then wafer sampling for metrology or defect control introduces a number of sub-routes derived from the above route as

FPᵢ→C₁B(C₁)→C₂B(C₂)→. . .→C_{N}B(C_{N})→FPᵢ.

In other words, scheduling algorithms must take into account the change in route introduced by metrology and defect control stations that are visited by some of the wafers from a wafer cassette in the factory interface, but not by all wafers from the wafer cassette.

Therefore, a need exists in the art for a method and apparatus to determine schedules for wafer movement through a wafer processing system comprising a cluster tool and a factory interface having metrology and defect control chambers.

### SUMMARY OF THE INVENTION

The invention is a method and apparatus for scheduling wafer processing in cluster tools that have integrated metrology and defect control stations or chambers. These are cluster tools with a Factory Interface (FI) (i.e., a combination of a robot and wafer cassette(s)), Integrated Particle Measurement (IPM) station or/and Integrated Metrology (IM) station as well as orient or center-find chambers. FI in the context of this invention is viewed as a cluster of stations or chambers having up to N chambers/stations, a transfer space supporting a choice of robots and scheduling algorithms that facilitate movement of the wafers, and a “mini-stocker” with capacity C wafer cassettes. The cluster tool is “connected” to the FI via one or more single-wafer load-locks.

The invention computes an optimal schedule for moving wafers from the cassettes in the factory interface to the cluster tool and back to the cassette, while intermittently moving wafers into a metrology or defect control station.

### BRIEF DESCRIPTION OF THE DRAWINGS

The teachings of the present invention can be readily understood by considering the following detailed description in conjunction with the accompanying drawings, in which:

FIG. 1 depicts a factory interface having metrology chambers coupled to a cluster tool;

FIG. 2 depicts a dual robot factory interface with a pass-through chamber;

FIG. 3 depicts a flow diagram of priority-based feed-first process;

FIG. 4 depicts a flow diagram of a priority-based empty-first process; and

FIG. 5 depicts a flow diagram of a process for selecting a destination chamber in a factory interface having dual robots and a pass-through chamber.

To facilitate understanding, identical reference numerals have been used, where possible, to designate identical elements that are common to the figures.

### DETAILED DESCRIPTION

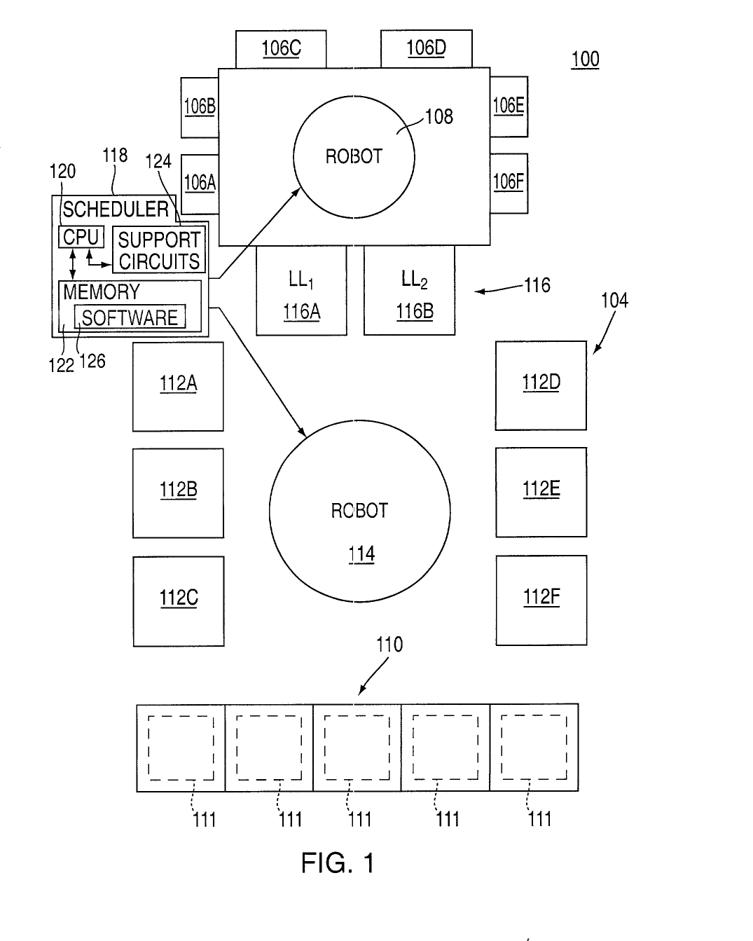

FIG. 1 depicts a schematic, block diagram of a semiconductor wafer processing system 100 comprising a cluster tool 102, a factory interface 104 and a scheduler 118. The cluster tool comprises a plurality of process chambers 106A, 106B, 106C, 106E), 106E and 106F, and a wafer transport robot 108. The factory interface 104 comprises one or more wafer cassette stockers 110, a plurality of stations 112A, 112B 112C, 112D, 112E and 112F, and a wafer transport robot 114. Wafer cassettes 111 are arranged in a multicassette stack known as a “mini-stocker” 110. The stations 112 comprise, for example, a metrology station 112A, a defect location station 112B, a wafer orienter 112C, and a wafer center-find station 112D. The factory interface 104 is coupled to the cluster tool 102 through one or more pass-through chambers 116 (load locks).

Wafers are moved one at a time from the cassettes(s) 110 by robot 114 to the pass-through chambers 116, the orienter 112C or the wafer center find station 112D. Once in chamber 116, the robot 108 moves the wafer from chamber 116 through the various chambers 106 of the cluster tool 102. After processing by the cluster tool 102, the wafer is returned to the pass-through chamber 116. The robot 114 then moves the wafer to a metrology station 112A and/or defect location station 112B. Lastly, the wafer is moved to a cassette 110.

The scheduling algorithm that facilitates wafer movement is implemented as an executable software routine 126. The scheduler 118 comprises a central processing unit (CPU) 120, memory 122 and support circuits 124. The CPU is a general purpose computer that becomes a specific purpose computer when executing software 126 stored in the memory. The memory 122 can be any form of digital storage including read only memory, random access memory, removable memory, hard disk drive and the like. The support circuits 124 are well-known circuits such as cache, clocks, power supplies and the like.

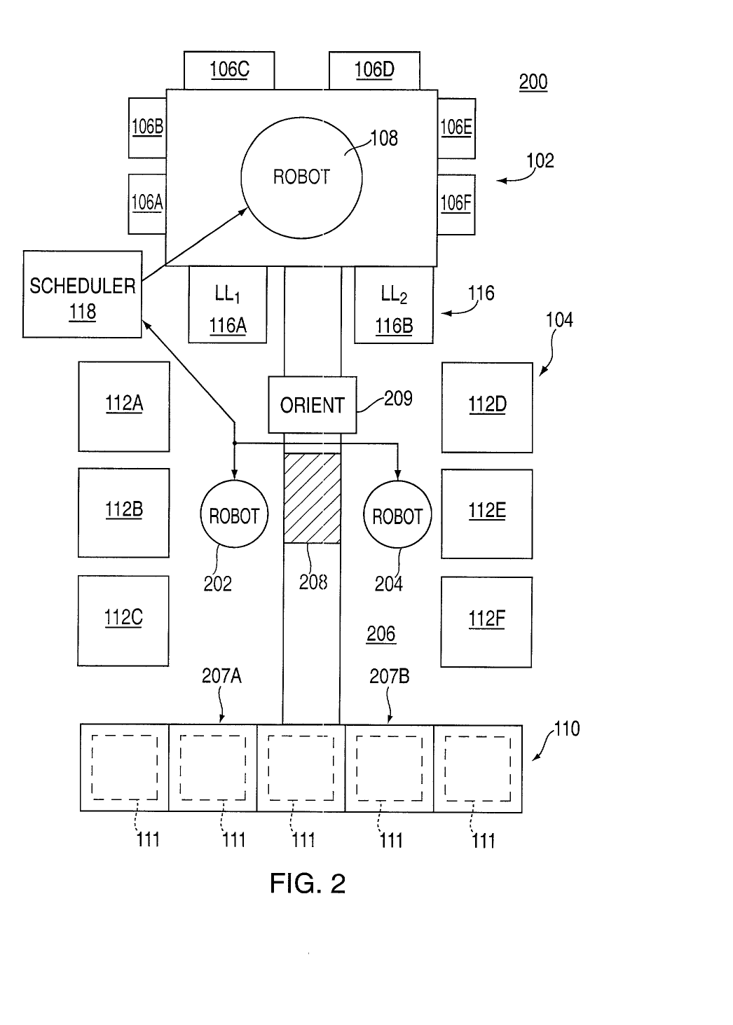

As shown in FIG. 2, multiple robots 202, 204 may be serving one transfer space 206 between the FI stations 112 A-F and the cluster tool 102. The wafers are passed from one robot to another by means of the pass-through chamber 208. As shown in FIG. 2, there may be two fixed robots 202, 204 in the FI transfer space 206. These are two single blade robots 202, 204 (with z-motion allowed) connected by a pass-through chamber of capacity four. Robots 202, 204 operate independent of each other. They are fixed and centered in front of their respective load-locks 116A, 116B and they both can access the orient chamber 209 that is positioned mid-way between the robots 202 and 204. Each robot services one load port 207A or 207B, pass-through chamber 208, orient chamber 209, N/2 metrology chambers 112 on one side, and one load-lock 116A or 116B. Clearly, in this case, a route for any wafer through the system should contain the robot identification (ID) visiting a chamber in the above sequence.

In another embodiment of the invention, a Single Wafer Load Lock (SWLL) is used between the FI 104 and the cluster tool 102. This load-lock is intended to hold only one wafer at a time during the pump/vent cycle of the load-lock. In addition to the existing 25-wafer load-lock logic, and single-wafer load-lock logic, this invention also contemplates a variable number of K+1 wafer slots assigned as inbound and outbound. Inbound slots are used to send up to K+1 wafers into the cluster tool and the same slots, denoted as outbound, are used for taking up to K+1 wafers out of the cluster tool. The K+1 slots are in the same volume that has to be pumped for wafers to go in and vented for wafers to go out of the tool. These K+1 slots are supposed to accommodate up to K wafers in case of single blade robots (either the tool's robot or the FI's robot) and up to K+1 wafers in case both tool and FI have dual blade robots.

Wafers entering a load-lock from FI are directed to either LL₁ or LL₂ depending on which load-lock is available to be loaded. If both load-locks were available, the wafer would enter the one that is closer to the wafer source station. Wafers leaving the transfer chamber are again directed to either LL₁ or LL₂, depending on which load-lock is available. If both load-locks were available, the wafer would enter the closer loadlock. The FI will return the wafer to the source pod cassette 110 into its original position (i.e., preserving the “slot integrity”). Wafers that enter the transfer chamber through LL₂ should not be restricted to exiting the transfer chamber through LL₂. Similarly, wafers from one cassette can enter either LL₁ or a LL₂ depending on the availability. In other words, wafers from one cassette are not restricted to entering and leaving the cluster tool 102 via a particular load-lock.

When particle monitoring stations and/or metrology stations are integrated with process equipment, there are several ways of specifying scheduling of wafers for inspection. These are,

1. Inspecting every N th wafer before and after processing. If N=1, every wafer is inspected, if N=2, every second wafer is inspected, if N=25, one wafer is inspected from each cassette.

2. Inspecting every N th wafer only after processing.

3. Assuming cluster tool with K identical chambers: inspecting before and after (or only after) every N th wafer processed in chamber J, where J ranges from 1 to K. So if N=3 every third wafer processed in chamber 1,2, . . . , K would be inspected.

4. Inspect as many wafers as possible before and after (or only after) without affecting the overall throughput of the process tool. This implies “background” inspection in the sense that the robot handles wafers for inspection only when it is idle. It also implies that processing never waits for inspection to be completed.

5. Inspect as many wafers as possible with up to T sec. addition to the overall processing time.

The invention accommodates the requirements related to scheduling in the presence of sampling of wafers (for inspection) in cluster tools.

Inspecting every N th wafer from a lot before and after processing can be implemented in two ways:

1. Specify that every N th wafer from a lot can be selected for inspection. For example, if N=1, then every wafer is inspected, when N=2, every second wafer is inspected, when N=25 one wafer is inspected from each cassette. If the cassette/lot size is less than the number specified, inspect the last wafer of the lot.

2. Specify by explicit enumeration of the sample wafers within a lot. For example, in a 25-wafer cassette a user can require wafers 1,2,6,9,13, and 25 to be inspected. If a particular wafer is not available, it can be ignored or can be defaulted to the last wafer in the cassette.

The above methods will work when all the wafers in the lot belong to the same product. If there are multiple products in a single lot, a technique has to be developed to identify the wafers in a lot by product. Wafers may need to be inspected before processing, after processing, or both before and after processing. Therefore, wafers' records within a database have to carry the necessary details about inspection before processing or after processing.

In a cluster tool with K identical chambers inspecting before and after (or only after) every N th wafer which visited the chamber J, where J ranges from 1 to K . So, if N=3, every third wafer processed in chamber 1,2, . . . , K is inspected. The N th wafer visit should be counted for the following wafers:

1. Of the same type of product (in case of more than one product)

2. Include the number of wafer visits to a chamber (in case of chamber revisits, the N th wafer visiting a chamber may not be the N th wafer processed in the chamber).

The data structure pertinent to the above-described implementation is given in Table 1.

TABLE 1

| | | 3 | | 5 | 6 | |
|---|---|---|---|---|---|---|
| 1 | 2 | Inspection Type (By | 4 | Go to an | Go to a | 7 |
| Process | Family | Frequency, By Wafer #, | Inspection | Inspection | Non Inspec- | Inspect |
| Step | Name | By Wafer visit in Chamber) | Wafers | Step | tion Step | When? |
| 1 | FOUPs* | By frequency | N = 2** | 2 | 3 | Before |
| 2 | FI inspect | | | 5 | | After |
| 3 | LL | By Wafer Number | X = 1,2,5*** | 4 | 5 | Both |
| 4 | Inspect2 | | | 5 | | |
| 5 | CVD (A,B,C) | By Wafer Visit in | y = 4**** | 6 | 7 | 7 |
| | | Chamber | | | | |
| 6 | Inspect2 | | | 7 | | |
| 7 | LL | | N = 1,2,5 | | | 8 |
| 8 | FI Inspect | | | 8 | | |

*FOUP is a Front Opening Unified Pod.
**N is the frequency of the inspection; i.e., every second wafer in the lot is inspected, refers to Step 1a).
***X is the specific inspection wafer numbers in the lot, refers to Step 1b)
****Inspect the Y-th wafer visiting the process chamber in a family. Corresponds to Step 2.

The above sampling requires the “inspection type” (in column three of the above table) to be a function with the following four arguments:

“inspection wafers”,

“go to inspection step”,

“go to non-inspection step”,

“inspect when”

which are columns 4-7 in the table. There are three “inspection type” methods:

a) “By number of wafer visits to chambers” (i.e., every K th wafer)

b) “By Frequency” (i.e., inspect every second wafer coming out from a cassette)

c) “By Wafer Number” (i.e., a particular wafer from a cassette)

Alternatively, as a wafer enters the system (FI plus cluster tool), the invention can associate a binary 2-tuple to the wafer record with the following meaning:

00 not inspected before and not after processing

01 not inspected before but inspected after processing

10 inspected before but not after processing

11 inspected before as well as after processing

When a process chamber is in the cluster tool and a metrology chamber is integrated into the FI, the requirement of measuring every K th wafer from a chamber requires setting a “metrology” bit, marked visited, in a wafer record to 1. This means that upon leaving the load-lock, that particular wafer (the K th wafer from chamber A) must visit the metrology chamber. This is an example of altering the wafer route based on the outcome in processing. The process chamber has a counter whose variable (content) count is reset after every K wafers, i.e.,

if count == K {
visited = 1; count = 0;
}
else {
visited = 0; count = count + 1;
}

To each wafer the invention thus associates a record in which various fields correspond to chambers being visited and are modified by the control system prior to or during the wafer processing. This data structure is instrumental in scheduling of wafers in case of integrated metrology or/and particle monitoring.

### Scheduling Algorithms

Wafers, that are marked “metrology” or “IPM” (i.e., have the corresponding bits set to one) visit their respective chambers according to a given scheduling logic. A priority based scheduling logic, which may be different than the logic used for “special” wafers, is then applied to “ordinary” wafers (i.e., wafers having no metrology field in their data structure). The following embodiments of the invention illustrate the modification on general versions of priority-based scheduling for both “feed-first” and “empty-first” types of scheduling algorithms.

Denote by T the length of a cassette stay in the system (cluster tool plus FI). It is assumed that pump and vent time for a cassette in a load-lock are overlapped with processing time of other cassettes, then, by Little's formula, it follows that in steady-state T=N/S, where N is the number of wafers in the cassette and S is the steady-state throughput. Thus, the length of a cassette stay in the system is minimized when the throughput is maximized and hence a scheduling logic that minimizes the length of a cassette's stay in the tool should be the best attainable.

A priority based scheduling routine should then assign the highest priority to a robot move that takes a wafer out of the cassette and puts the wafer into the first stage of a wafer's flow. A “stage” is a set of chambers that are executing the same process. Reasoning inductively, such an algorithm should give priorities n,n−1,n−2, . . . , 2,1 to stages 1,2, . . . , n−1,n, respectively. The load-lock should have the highest priority, n+1, when the wafer is to be taken out from the load-lock and the lowest priority, 0, when the (processed) wafer is to be returned to the load-lock. The above described algorithm is known as “wafer packing”, which is a variant of feed-first class of algorithms, and is optimum for serial configurations with process limited throughput. For a description of “wafer packing” and other priority based scheduling algorithms, see U.S. Pat. No. 5,928,389, issued Jul. 27, 1999.

Recall that the wafer record contains metrology and defect control fields according to the above description of the data structure needed in scheduling of the wafers. If these fields have variables set to 1, hereafter, these wafers are referred to as M-wafers. Clearly, M-wafers should not receive any special treatment in scheduling in the sense of initiating the movement of these wafers out of order dictated by the scheduling algorithm. However, once they become a source wafer (that is, a wafer to be moved according to the algorithm), their target chamber is different than the ones for “ordinary” wafers. For example, while an ordinary wafer is moved from a load-lock back to its position in the cassette, an M-wafer first visits metrology chamber and then the wafer returns to the cassette. So, all scheduling algorithms are augmented by first reading a metrology or defect control field in the data structure associated with scheduling needs of a wafer that is to be moved.

In a priority-based feed-first algorithm, a wafer transfer starts by identifying a chamber pair (C_{S},C_{D}) , C_{S} and C_{D} being a source and a destination (also called target) chamber, respectively. In feed-first algorithms, in particular, chamber C_{D} is chosen first. In empty-first algorithms, chamber C_{S} is chosen first. An example of such a data structure (without metrology and defect detection fields) for implementation of priority-based heuristics is given in [1].

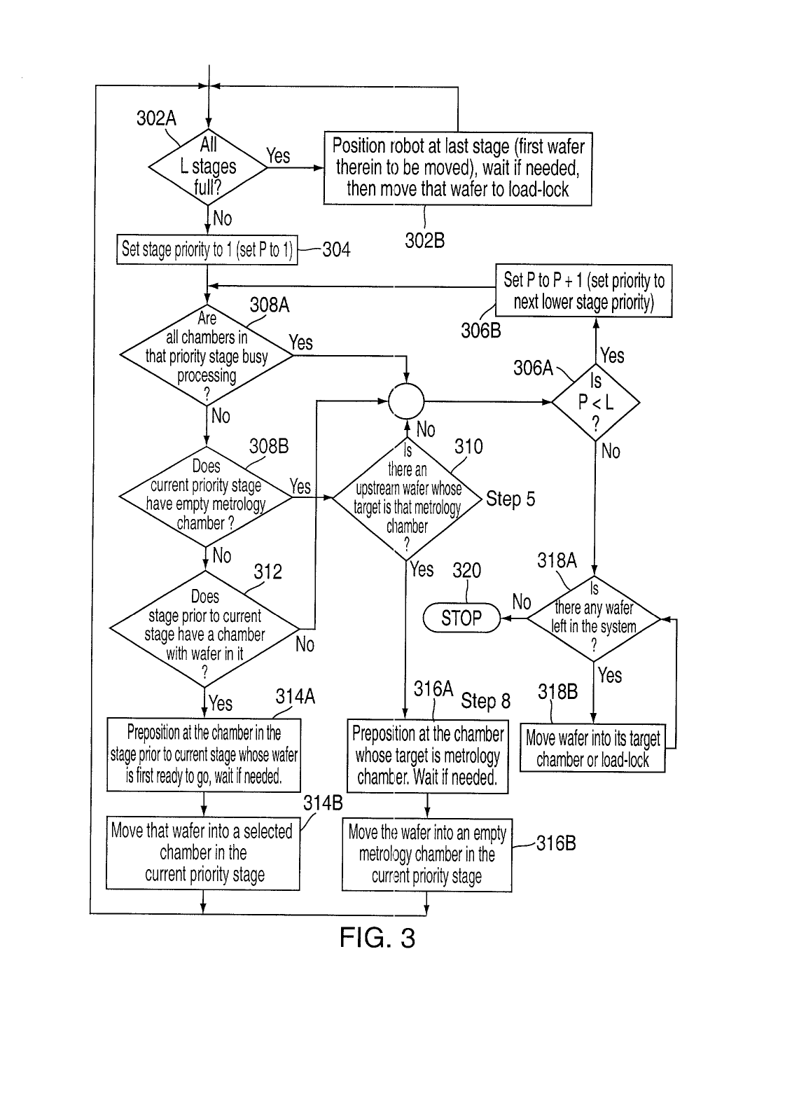

If C_{D} is chosen first and C_{D} happens to be a metrology chamber, upstream stages are scanned for a wafer whose “metrology bit” is set to 1 (and thus whose target chamber is C_{D} ). If such a wafer is identified, the transfer is made; else, the priority number is decreased by one and the search is repeated. FIG. 3 depicts a flow diagram of a priority-based, feed first algorithm 300. The following algorithm is repeated for each independent robot space:

Step 302 and 302B. If all stages are full, preposition the robot at the chamber in the last stage whose wafer is first ready to leave the chamber. Wait if necessary, and then move that wafer into its position in the cassette (cassette is sitting on the load-port). Go to Step 304.

Step 304. Set the stage priority P to one (P←1) and go to Step 308. (This is a usual assignment to a variable “stage priority”.)

Step 306A and 306B. If P<L (306A), then P←P+1 (306B) (decrease priority) and go to Step 308. Else (P≧L), go to Step 318A.

Step 308A and 308B. If all chambers in the current priority stage are busy either processing or cleaning, go to Step 306A. Else if the current priority stage (i.e., stage with priority P) has an empty metrology chamber (empty means ready to receive a wafer), go to Step 310. Else (there is an empty non-metrology chamber), go to Step 312.

Step 310. Scan all upstream chambers for a wafer whose metrology bit is set to one and whose (next) target chamber is a metrology chamber identified in Step 308B. If there is no such a wafer, go to Step 306A.

Else, go to Step 318A.

Step 312. If the stage or load-lock that is right before the current priority stage has at least one chamber with (product) wafer in it, go to Step 314A. Else (the stage is empty), go to Step 306A.

Step 314A and 314B. Preposition (314A) the robot at a chamber in the stage right before the current priority stage (found in Step 6) whose wafer is first ready to go. Wait if necessary, and move (314B) that wafer into an empty chamber in the current priority stage. Go to Step 302A.

Step 316A and 316B. Preposition (316A) the robot at a chamber found in Step 313. Wait if necessary, and move (316B) the wafer within into an empty metrology chamber in the current priority stage. Go to Step 302A.

Step 318A and 318B. If there are any wafers left in the system (318A), move (318B) them into their target chambers or FA in the order of completion. Else, STOP at step 320.

As already mentioned, the above algorithm searches for a pair of stages Sₚ and S_{q} such that the following two conditions hold:

Sₚ is the current highest priority stage and has at least one empty chamber,

For “ordinary wafers”, S_{q} is the stage right before Sₚ (i.e. chambers in Sₚ are target for the wafers from S_{q}) which has at least one non-empty chamber (with a wafer ready to go into stage Sₚ at some point in time). For M-wafers, S_{q} is a stage prior to sₚ (not necessarily right before Sₚ) which contains a wafer whose target chamber is a metrology chamber.

The above algorithm can be extended into a gamma-tolerant version in a way similar to that described in U.S. Pat. No. 5,928,389, issued Jul. 27, 1999.

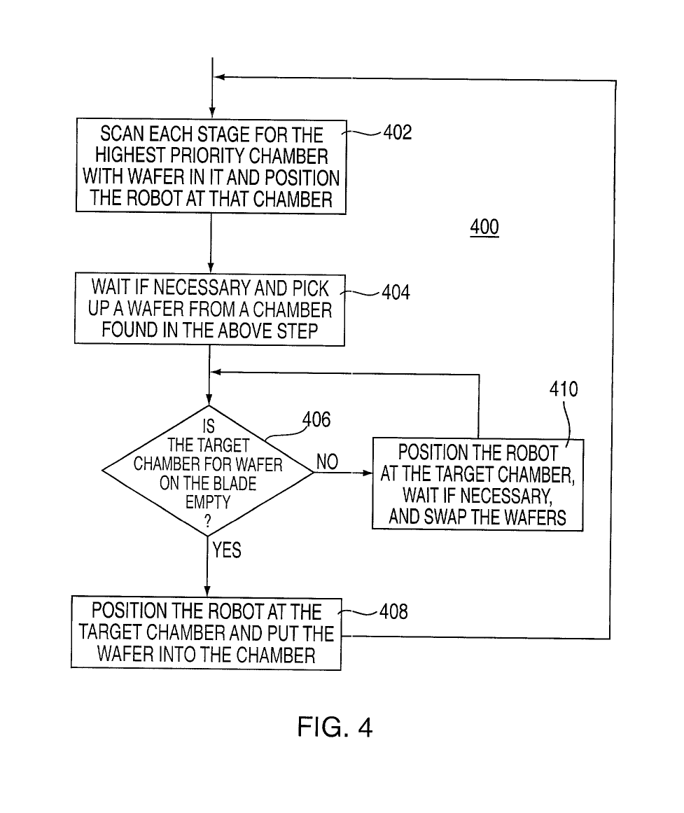

In a priority-based empty-first algorithm, the highest priority non-empty source chamber is first identified. In case of single blade transporters, the move is made only if the target chamber is available. In case of dual (multiple) blade transporters, the move is made regardless (because one of the blades can serve as a temporary wafer-holding position). FIG. 4 depicts a flow diagram of a priority based, empty first algorithm 400 that pertains to dual-blade robots.

Step 502. Scan each stage of the system to find a chamber that has the highest priority and a wafer in it. Position the robot (any blade) in front of the highest priority chamber. Go to Step 504.

Step 504. Wait if necessary and pick up a wafer from the chamber found in Step 502. Go to Step 506.

Step 506. If the target chamber for the wafer on the blade is empty, go to Step 508. Else, go to Step 510.

Step 508. Position the full blade in front of the target chamber and put the wafer into the chamber. Go to Step 502.

Step 510. Position the empty blade in front of the target chamber. If necessary, wait until wafer in the target chamber is ready to move. Swap the wafer on the blade with the wafer in the target chamber (according to the type of a robot). Go to Step 506.

Note that neither M-chambers nor wafers requesting such chambers have a separate treatment in the above algorithm. It is only that target chamber in the wafer exchange is determined by first looking at the “metrology field” of a data structure associated with the wafer.

### Managing the Pass-Through Chamber in FI

A transfer space in FI may contain one or two robots. In case of two fixed robots, as described previously, robots service their respective regions and exchange the material (wafers) through either an orient chamber or through a multiple slot pass--through chamber. Below is described a data structure and algorithms needed for an effective management of a pass-through chamber.

As already mentioned the two fixed robots in the FI transfer space are single blade robots (with z-motion allowed) connected by a pass-through chamber of capacity four. Robots are independent of each other and centered in front of their respective load-lock positions and they both can access the orient chamber that is positioned mid-way between them. Each robot services one load port, pass-through chamber, orient chamber, metrology chambers on one side, and one load-lock. So, if RS, represents robot space i, where i=1,2, then

RSᵢ={FPᵢOᵢ,M₁⁽ⁱ⁾, M₂⁽ⁱ⁾, M₃⁽ⁱ⁾,LLᵢ}, i=1,2.

In the above set, FPᵢ stands for the FOUP position i (also, load position i), Oᵢ is the orient position accessible by robot iᵢ Mₖ⁽ⁱ⁾ is the kth metrology chamber, and LLᵢ is the load-lock i. Clearly, the Pass Through (PT) chamber is visited whenever wafer goes from RSᵢ to RSⱼ and i≠j. With SC, TC, and PTC, denoting a Source Chamber, Target Chamber and Pass-Through Chamber, respectively, as such,

if SC ε RS₁ {
if TC ε RS₁

SC ← PTC;

}

which sets pass-through chamber (PTC) as a new source chamber (i.e., after the robot moves wafer to pass-through). Target chamber remains unchanged. The robot deployment is then described by the following

if SC == PTC ∥ SC == O {

if TC ε RS₁

return ROBOT₁

else if SC ε RS₁&&TC ε RS₁

return ROBOT₁

else return ROBOT₂
}

Once wafer is in pass-through chamber, the wafer's target chamber (i.e., the wafer's next move) is determined from a previous source chamber (this is the chamber that had PTC as a target). Thus the algorithm becomes,

If SC == PTC {
If TC == FA_Load
SC ← FA_Load
else if PSC ε RS₁

TC ε RS₂

else if PSC ε RS₂

TC ε RS₁

}

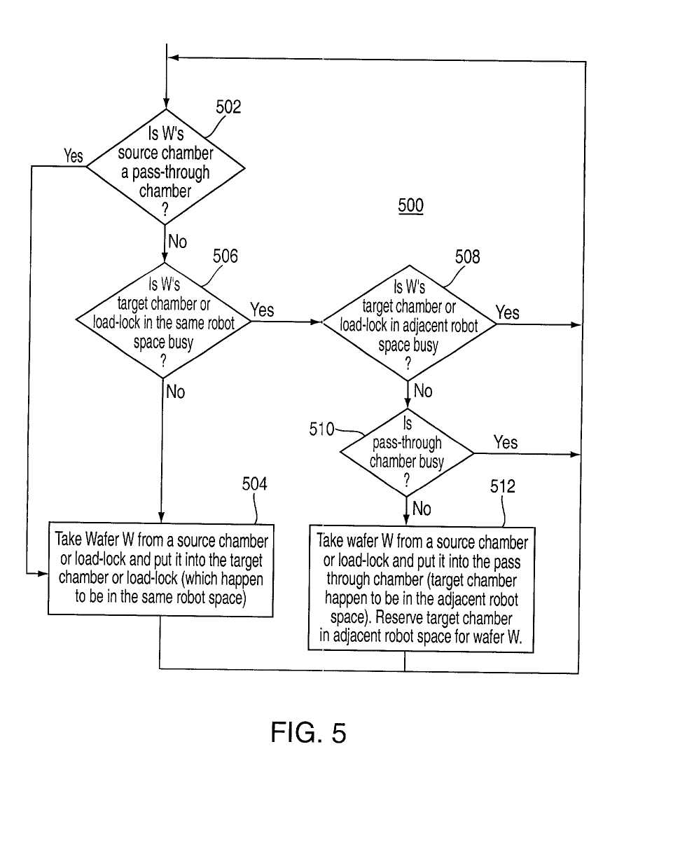

FIG. 5 depicts a flow diagram representing an algorithm 500 that handles a pass-through chamber. A wafer to be moved is sitting either in a pass-through chamber or orient chamber (also called an aligner) or elsewhere (e.g., FOUP load position, load-lock, an IPM or metrology chamber). At step 502, the process 500 queries whether the source chamber is a pass through chamber. If the query is negatively answered, the process proceeds to step 506 where the process queries whether the target chamber or load-lock in the same robot space as the source chamber is busy. If that target chamber or load-lock is not busy, the routine proceeds to step 504. If the query at step 502 is affirmatively answered, the process proceeds to step 504.

At step 504, the process takes the wafer W from the source chamber or load-lock and places the wafer W into the target chamber or load-lock, where both the target and source chambers or load-locks are in the same robot space. The process then returns to step 502.

If, at step 506, the query was affirmatively answered, the process 500 proceeds to step 508. At step 508, the process queries whether the target chamber or load-lock in an adjacent robot space is busy. If the query is affirmatively answered, the wafer W cannot be moved at this time, so the process returns to step 502. If the query is positively negatively answered, then the process 500 proceeds to step 510. In step 510, the process 500 queries whether the passthrough chamber is busy. If the query is affirmatively answered, the wafer W cannot be moved from one robot space to the other through the pass-through chamber. As such, the process returns to step 502.

If the query at step 510 is negatively answered, then the process 500 proceeds to step 512, where the wafer W is moved into the pass-through chamber. Additionally, the target chamber in the adjacent robot space is reserved for the wafer W that is now positioned in the pass-through chamber. The process 500 then returns to step 502.

An alternative way to express the above scheduling logic is via the sub-routes of a complete wafer route. The full wafer route involves the following stages:

| | |
|---|---|
| FA Load Ports | {FP1, FP2} |
| Orient Chamber | {0} |
| Pass Through Chamber | {PTC1, . . . , PTC4} |
| Metrology Chamber | {MC1, . . . , MC6} |
| Pass Through Chamber | {PTC1, . . . , PTC4} |
| Load-Locks | {LL1, LL2} |
| Cluster Tool | {List Wafer Flow} |
| Load-Locks | {LL, LL2} |
| Pass Through Chamber | {PTC1, . . . , PTC4} |
| Metrology Chamber | {MC1, . . . , MC6} |
| Pass Through Chamber | {PTC1, . . . , PTC4} |
| FA Load Ports | {FP1, FP2} |

A wafer starts and ends with the same FA Load Port. The sub-route is obtained by deleting a stage (e.g. pass-through chamber or metrology chamber) from the above route and specifying location in the stage (e.g. LL1 or LL2, FP1 or FP2, etc.) See U.S. patent application Ser. No. 09/523,409 filed Mar. 10, 2000, which is hereby incorporated herein by reference, for detailed description of a calculation of timing in wafer arrivals (departures) to (from) pass-through chamber.

### Deadlock Handling

When there is only one metrology or defect control chamber in the FI and the sampling policy is to inspect wafers before entering and after leaving the tool, a “simple” processing loop is formed. A load-lock, pass-through chamber, orient, metrology or IPM chamber, and the FA_Load position form the loop. Here, metrology or inspection chamber is the knot chamber. Algorithms which handle processing loops in cluster tools are described in U.S. patent application Ser. No. 09/074,122, filed May 7, 1998, (attorney docket number 2331), which is herein incorporated by reference. Depending on the type of deadlock handling (i.e., avoidance or resolution), these algorithms may require slight adaptation to new conditions induced by sampling.

Although various embodiments that incorporate the teachings of the present invention have been shown and described in detail herein, those skilled in the art can readily devise many other varied embodiments that still incorporate these teachings.

What is claimed is:

1. A method for scheduling semiconductor wafers for processing within a multiple chamber, semiconductor wafer processing system having a plurality of chambers and at least one metrology or defect control chamber, said method comprising:
assigning a priority to each chamber in said plurality of chambers;
identifying certain wafers as metrology wafers that shall be moved into at least one metrology or defect control chamber;
selecting a chamber having a highest priority;
moving a wafer from a selected chamber to a target chamber in accordance with the assigned priority of the selected chamber, unless the wafer is a metrology wafer that is then moved into at least one metrology or defect control chamber.

2. The method of claim 1 wherein, if a plurality of chambers have the highest priority, the selecting step further comprises the step of selecting a chamber having a highest priority and having a shortest remaining process time.

3. The method of claim 1 wherein said plurality of chambers is accessed by a first robot and said at least one metrology or defect control chamber is accessed by a second robot.

4. The method of claim 3 wherein a factory interface comprises two metrology chambers, wherein the method further comprises:
accessing a first metrology chamber with a first factory interface robot;
accessing a second metrology chamber with a second robot that is proximate a pass through chamber; and
passing wafers from said first factory interface robot to said second factory interface robot using a pass-through chamber.

5. The method of claim 4 wherein said first factory interface robot and said second factory interface robot both access a wafer orientation chamber.

6. The method of claim 5 wherein the first factory robot operates in a first robot space and the second factory robot operates in a second robot space, the method further comprising:
determining if a source chamber of a wafer is the pass-through chamber and, if the source chamber is the pass-through chamber, removing the wafer from the source chamber and placing the wafer into a target chamber;
if the source chamber is not a pass-through chamber, determining if a target chamber for the wafer is busy and, if the target chamber is busy, waiting until the target chamber is not busy, then moving the wafer to the target chamber;
if the target chamber is in an adjacent robot space, then the wafer is moved to the pass-through chamber or an orient chamber and the target chamber is reserved to ensure that the target chamber will not be busy when the wafer is moved from the pass-through chamber or the orient chamber to the target chamber.

7. Apparatus for scheduling semiconductor wafers for processing within a multiple chamber, semiconductor wafer processing system having a plurality of chambers and at least one metrology chamber, said apparatus comprising:
a sequencer for assigning a priority to each chamber in said plurality of chambers and for selecting a chamber having a highest priority and for selecting wafers for placement into at least one metrology chamber; and
at least one wafer transfer robot, coupled to said sequencer, for moving a wafer from a selected chamber to a target chamber in accordance with the assigned priority of the selected chamber and for moving selected wafers into at least one metrology chamber.

8. The apparatus of claim 7 wherein, if a plurality of chambers have the highest priority, the sequencer selects a chamber having a highest priority and having a shortest remaining process time.

9. The apparatus of claim 7 further comprising a factory interface comprising said at least one metrology chamber and at least one factory interface robot.

10. The apparatus of claim 8 wherein said factory interface further comprises a pass through chamber.

11. The apparatus of claim 8 further comprising a wafer orientation chamber.

12. The apparatus of claim 9 wherein said at least one wafer factory interface robot comprises two wafer transport robots that transfer wafers between each other through the passthrough chamber.

13. A storage medium for storing instructions that, when executed by a computer, cause a semiconductor wafer processing system to perform a method for scheduling semiconductor wafers for processing within a multiple chamber, semiconductor wafer processing system having a plurality of chambers and at least one metrology chamber, said method comprising:
assigning a priority to each chamber in said plurality of chambers;
identifying certain wafers as metrology wafers that shall be moved into at least one metrology chamber;
selecting a chamber having a highest priority;
moving a wafer from a selected chamber to a target chamber in accordance with the assigned priority of the selected chamber, unless the wafer is a metrology wafer that is then moved into at least one metrology chamber.

14. The method of claim 13 wherein, if a plurality of chambers have the highest priority, the selecting step further comprises the step of selecting a chamber having a highest priority and having a shortest remaining process time.

15. The method of claim 13 wherein said plurality of chambers is accessed by a first robot and said at least one metrology chamber is accessed by two robots.

16. The method of claim 15 wherein a factory interface comprises two metrology chambers, wherein the method further comprises:
accessing a first metrology chamber with a first factory interface robot;
accessing a second metrology chamber with a second robot that is proximate a pass through chamber; and
passing wafers from said first metrology robot to said second metrology robot using a pass-through chamber.

17. The method of claim 16 wherein said first factory interface robot and said second factory interface robot access a wafer orientation chamber.

18. The method of claim 16 wherein the first factory robot operates in a first robot space and the second factory robot operates in a second robot space, the method further comprising:
determining if a source chamber of a wafer is the pass-through chamber and, if the source chamber is the pass through chamber, removing the wafer from the source chamber and placing the wafer into a target chamber;
if the source chamber is not a pass-through chamber, determining if a target chamber for the wafer is busy and, if the target chamber is busy, waiting until the target chamber is not busy, then moving the wafer to the target chamber;
if the target chamber is in an adjacent robot space, then the wafer is moved to the pass-through chamber and the target chamber is reserved to ensure that the target chamber will not be busy when the wafer is moved from the pass-through chamber to the target chamber.
